(19) United States
(12) Patent Application Publication
(10) Pub. No.: US 2007/0247045 A1
(43) Pub. Date: Oct. 25, 2007

(54) PLASMA DISPLAY DEVICE

(75) Inventors: Won-Kyu Bang, Suwon-si (KR); Myoung-Kon Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/687,231

(22) Filed: Mar. 16, 2007

(30) Foreign Application Priority Data
Apr. 21, 2006 (KR) 2006-36333

(51) Int. Cl. H01J 61/52

(52) U.S. Cl. 313/46

(57) ABSTRACT

A plasma display device to prevent damage to a signal transmission unit by improving the shape of a cover plate covering the signal transmission unit. The plasma display device includes: a plasma display panel; a chassis base installed at rear of the plasma display panel; a circuit unit installed at rear of the chassis base; a plurality of signal transmission units surrounding the edge of the chassis base, each of which has one end connected to the circuit unit and the other end extending to the plasma display panel to transmit an electrical signal from the circuit unit to the plasma display panel, wherein the signal transmission units comprise electronic elements; and a cover plate covering the electronic elements and the signal transmission unit and embossed with protrusions toward the signal transmission unit so as to be spaced apart from the electronic elements.

### CROSS-REFERENCE TO RELATED APPLICATIONS

This application claims the benefit of Korean Patent Application No. 2006-36333, filed on Apr. 21, 2006 in the Korean Intellectual Property Office, the disclosure of which is incorporated herein by reference.

### BACKGROUND OF THE INVENTION

1. Field of the Invention

Aspects of the present invention relate to a plasma display device, and more particularly, to a plasma display device having an improved cover plate to prevent damage to a signal transmission unit.

2. Description of the Related Art

Plasma display devices use plasma display panels, which are flat display devices displaying an image using gas discharge. These displays have several advantages, such as a large screen, a high-quality image display, a high contrast, a thin and light design, less image sticking, and a wide-range viewing angle. As a result, plasma display devices have attracted considerable attention as next-generation large-sized flat display devices.

A plasma display device typically includes a plasma display panel (PDP), a chassis base supporting the PDP, a circuit unit that drives the PDP, and a case. The plasma display device further includes a signal transmission unit by which signals are transmitted between the PDP and the circuit unit and on which an electronic element, such as an integrated circuit, is mounted. To provide a thin plasma display device, a signal transmission unit is conventionally placed on a lower portion of a chassis base.

However, when an external force is applied to the chassis base, or a reinforcement installed on the rear surface of the chassis base is bent by heat generated during operation of the plasma display device, the signal transmission unit is damaged. Also, during the manufacture of the plasma display device, workers often hold the lower portion of the chassis base, where the signal transmission unit is located. Consequently, excessive force is applied to the signal transmission unit, often damaging the signal transmission unit.

### SUMMARY OF THE INVENTION

Aspects of the present invention provide a plasma display device capable of preventing damage to a signal transmission unit by improving the shape of a cover plate covering the signal transmission unit.

According to an aspect of the present invention, there is provided a plasma display device comprising: a plasma display panel to display an image; a chassis base installed at the rear of the plasma display panel to support the plasma display panel; a circuit unit installed at the rear of the chassis base to generating an electrical signal for driving the plasma display panel; a plurality of signal transmission units surrounding the edge of the chassis base, each of which having one end connected to the circuit unit and the other end extending to the plasma display panel while to transmit an electrical signal from the circuit unit to the plasma display panel, wherein each of the plurality of signal transmission units comprise electronic elements; and a cover plate covering the electronic elements and the signal transmission unit and embossed with protrusions toward the signal transmission unit so as to space the cover plate apart from the electronic elements.

According to another aspect of the present invention, the electronic elements may be formed to face at least one side surface of the chassis base.

According to another aspect of the present invention, the plasma display device may further include a reinforcement installed on a rear surface of the chassis base.

According to another aspect of the present invention, the signal transmission unit may be a tape carrier package.

According to another aspect of the present invention, a heat conductive sheet may be installed between the cover plate and the signal transmission unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display device according to an embodiment of the present invention;

FIG. 2 is a cross-section taken along line I-I of FIG. 1; and

FIG. 3 is a magnified cross-section illustrating a relationship between positions of electronic elements and a cover plate in portion A of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

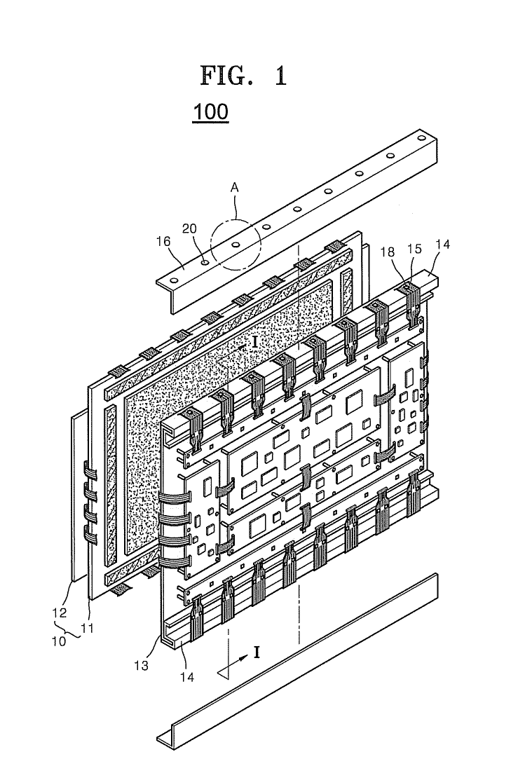

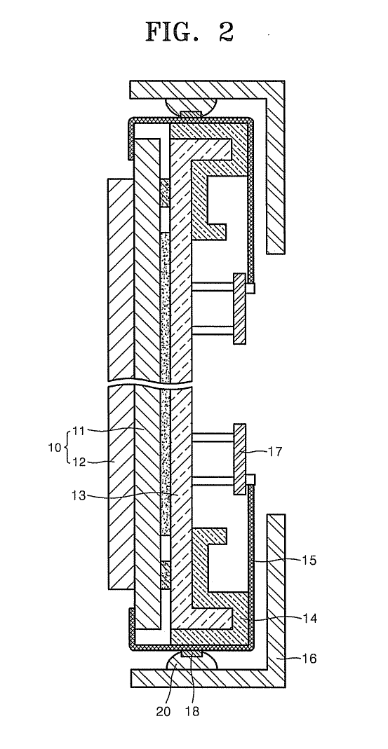

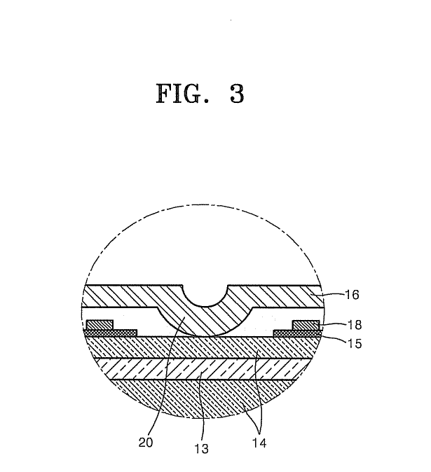

FIG. 1 is an exploded perspective view of a plasma display device 100 according to an embodiment of the present invention. FIG. 2 is a cross-section taken along line I-I of FIG. 1. FIG. 3 is a magnified cross-section illustrating a relationship between positions of electronic elements and a cover plate in portion A of FIG. 1. Referring to FIGS. 1 through 3, the plasma display device 100 is roughly divided into a plasma display panel (PDP) 10, a chassis base 13, and a circuit unit 17.

The PDP 10, which displays an image, includes a front panel 12 and a rear panel 11 facing each other. A plurality of electrodes, to which a voltage is applied, may be arranged on the front panel 12 and the rear panel 11. These electrodes may be covered with dielectric layers. Barrier ribs to define a plurality of cells where discharge occurs may be formed between the front panel 12 and the rear panel 11. Phosphor layers and discharge gas may exist within the cells. A chassis base 13 may be installed at the rear of the PDP 10.

The chassis base 13 supports the PDP 10 and is attached to the PDP 10 by an adhering unit such as a dual adhesive tape or other adhesive. The chassis base 13 receives and discharges heat generated in the PDP 10. To achieve this function, the chassis base 13 may be formed of a high thermal emissive material such as aluminum. The chassis base 13 may be manufactured by casting, press working, or other techniques. A thermal conductive medium (not shown) such as a heat conductive sheet may be interposed between the PDP 10 and the chassis base 13. Other aspects of the invention may use other techniques to dissipate excess heat.

A thermal conductive medium transmits heat generated in a PDP during operation of the plasma display device 100 to the chassis base 13 in order to easily discharge the heat outside. A reinforcement 14 may be installed on the rear surface of the chassis base 13. The reinforcement 14, which prevents bending and twisting of the chassis base 13, may be formed of material such as aluminum, though any material may be used.

A circuit unit 17 is installed at rear of the chassis base 13. The circuit unit 17 generates an electrical signal to operate the PDP 10 and transmits the electrical signal to the PDP 10. A signal transmission unit 15 is installed between the circuit unit 17 and the PDP 10 in order to connect the circuit unit 17 to the PDP 10.

The signal transmission unit 15, by which electrical signals are transmitted between the circuit unit 17 and the PDP 10, may be, for example, a tape carrier package or a flexible printed cable. Other devices capable of transmitting electric signals may be used as well. An electronic element 18m, such as an integrated circuit, to switch a signal transmission from the circuit unit 17 to the PDP 10 on or off, may be mounted on the signal transmission unit 15.

When the signal transmission unit 15 is installed between the circuit unit 17 and the PDP 10, the electronic elements 18 may be arranged on upper and lower surfaces of the chassis base 13. This arrangement reduces the thickness of the plasma display device by a thickness of the electronic elements 18. A cover plate 16 is installed at the rear of the chassis base 13 so as to surround the signal transmission unit 15 on which the electronic element 18 is mounted.

The cover plate 16 discharges heat generated by the electronic element 18 and the signal transmission unit 15 and resists external forces that could damage the signal transmission unit 15. The cover plate 16 is fixed to the rear surface of the chassis base 13 by screws or other fasteners. The screws (or other fasteners) are coupled to portions of the chassis base 13 other than the portions where the electronic elements 18 are installed.

In a conventional plasma display device, electronic elements on a signal transmission unit may be damaged when a chassis base or a reinforcement is bent. Also, during the manufacture of the plasma display device, workers hold the lower portion of the chassis base where the signal transmission unit 15 is located. Consequently, excessive force may be applied to the signal transmission unit 15, damaging the signal transmission unit 15.

To solve these problems, the cover plate 16 is embossed with protrusions 20 so as to space the cover plate 16 apart from the electronic elements 18 of the signal transmission unit 15. Due to the protrusions 20, even when force is applied to the cover plate 16, the cover plate 16 does not contact the electronic elements 18, preventing damage to the electronic elements 18.

As illustrated in FIG. 3, the protrusions 20 are arranged at intervals so as not to contact the electronic element 18 mounted on the signal transmission unit 15. To accelerate emission of heat from the electronic element 18, a thermal conductive medium, such as a heat conductive sheet, may be formed between the cover plate 16 and the electronic element 18.

A plasma display device according to aspects of the present invention improves the shape of a cover plate that covers a signal transmission unit, thereby preventing the signal transmission unit from being damaged.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel to display an image;
a chassis base installed at the rear of the plasma display panel, to support the plasma display panel;
a circuit unit installed at the rear of the chassis base to generate an electrical signal to operate the plasma display panel;
a plurality of signal transmission units surrounding the edge of the chassis base, each of which having one end connected to the circuit unit and the other end extending to the plasma display panel, to transmit an electrical signal from the circuit unit to the plasma display panel, wherein each of the plurality of signal transmission units comprises electronic elements; and
a cover plate covering the electronic elements and the signal transmission unit embossed with protrusions facing the signal transmission unit so as to space the cover plate apart from the electronic elements,
wherein the electronic elements are formed to face at least one side surface of the chassis base.

2. The plasma display device of claim 1, further comprising a reinforcement installed on a rear surface of the chassis base.

3. The plasma display device of claim 1, wherein the plurality of signal transmission units each comprises a tape carrier package.

4. The plasma display device of claim 1, further comprising a heat conductive sheet between the cover plate and the signal transmission unit.

5. The plasma display device of claim 1, wherein the plurality of signal transmission units each comprises a flexible printed cable.

6. The plasma display device of claim 1, wherein the protrusions are disposed between the electronic elements.

7. A component to reduce an excessive force applied to signal transmission units in a plasma display device, the component comprising:
a cover plate covering the signal transmission units and embossed with protrusions facing electronic elements within the signal transmission units, wherein the cover plate is spaced apart from the electronic elements.

8. The component according to claim 7, wherein the protrusions are disposed between the electronic elements within the signal transmission units so as to space the cover plate apart from the electronic elements.

9. The component according to claim 7, wherein the cover plate contacts, in at least one position, a chassis base upon which the signal transmission units are located, but does not contact the electronic elements.
